(19) United States
(12) Patent Application Publication
(10) Pub. No.: US 2025/0329881 A1
(43) Pub. Date: Oct. 23, 2025

(54) STACKED ELECTRODE ASSEMBLY AND POWER STORAGE MODULE

(71) Applicant: TOYOTA JIDOSHA KABUSHIKI KAISHA, Aichi-ken (JP)

(72) Inventors: Jun IZUMI, Toyota-shi (JP); Yusuke IKEDA, Miyoshi-shi (JP); Tetsuya MIMURA, Chiryu-shi (JP); Tomofumi HIRUKAWA, Miyoshi-shi (JP); Hajime HASEGAWA, Aichi-gun (JP); Shizuka MASUOKA, Nagoya-shi (JP); Hiroki AWANO, Susono-shi (JP); Kosuke YONEKAWA, Nisshin-shi (JP)

(21) Appl. No.: 19/171,349

(22) Filed: Apr. 7, 2025

(30) Foreign Application Priority Data
Apr. 18, 2024 (JP) 2024-067542

(51) Int. Cl. H01M 50/46; H01M 50/463; H01M 50/627

(52) U.S. Cl. CPC H01M 50/46; H01M 50/463; H01M 50/627

(57) ABSTRACT

A stacked electrode assembly includes a plurality of electrodes and a plurality of separators. The electrode and the separator are alternately stacked in a first direction. The stacked electrode assembly extends in a second direction perpendicular to the first direction. The stacked electrode assembly further includes a circumferential surface extending in the second direction. A length of the separator in a third direction perpendicular to the first and second directions is longer than a length of the electrode in the third direction. The circumferential surface has first and second primary surfaces in the first direction and first and second side surfaces in the third direction, the first and second side surfaces continuing to the first and second primary surfaces, respectively. The separator is welded on at least one of the first side surface and the second side surface across a length of the stacked electrode assembly in the first direction.

### CROSS REFERENCE TO RELATED APPLICATIONS

This nonprovisional application is based on Japanese Patent Application No. 2024-067542 filed on Apr. 18, 2024, with the Japan Patent Office, the entire content of which is hereby incorporated by reference.

### BACKGROUND

### Field

The present disclosure relates to a stacked electrode assembly and a power storage module.

### Description of the Background Art

Conventionally, power storage modules are known. Japanese Patent Laying-Open No. 2012-209054 discloses an electrode assembly (a stacked electrode assembly) consisting of stacked cells which are power storage modules. In the electrode assembly, multiple electrodes are stacked with separators in-between. At multiple locations around the electrodes, the electrode assembly includes separator joints collectively joining the stacked separators. The movement of the electrodes in a direction intersecting with the laminate direction of the electrode assembly is restricted at these locations.

### SUMMARY

In Japanese Patent Laying-Open No. 2012-209054, the locations of the separator joints relative of the laminate direction of the electrode assembly are the same as the locations of the separators disposed midway or at the lower end in the laminate direction. Portions of the separators, except for those disposed midway or at the lower end, extend from the respective outer edges of the stacked positive and negative electrodes toward the separator joints. Accordingly, in Japanese Patent Laying-Open No. 2012-209054, a large space not contributing to charging and discharging has to be provided, extending from the respective outer edges of the stacked positive and negative electrodes to the separator joints.

The present disclosure provides a stacked electrode assembly which have a reduced space not contributing to charging and discharging, while misalignment of the separators is prevented.

According to a certain aspect of the present disclosure, a stacked electrode assembly includes a plurality of electrodes and a plurality of separators. Each of the electrodes and each of the separators are alternately stacked in a first direction. The stacked electrode assembly extends in a second direction perpendicular to the first direction. The stacked electrode assembly further includes a circumferential surface extending in the second direction. A length of the separator in a third direction perpendicular to the first direction and the second direction is longer than a length of the electrode in the third direction. The circumferential surface has first and second primary surfaces in the first direction and first and second side surfaces in the third direction, the first and second side surfaces continuing to the first and second primary surfaces, respectively. The separator is welded on at least one of the first side surface and the second side surface across a length of the stacked electrode assembly in the first direction.

With the above configuration, the separators are welded on at least one of the first side surface and the second side surface across the length of the stacked electrode assembly in the first direction. Therefore, the movement of the separators in the third direction within the stacked electrode assembly is restricted. Accordingly, the misalignment of the separators can be prevented. Furthermore, with the above configuration, the amounts of protrusions of the separators from the outer edges of the electrodes can be reduced. Accordingly, a reduced space not contributing to charging and discharging can be achieved.

Preferably, the separator is welded together at a plurality of locations separate from each other in the second direction across the length of the stacked electrode assembly in the first direction.

With the above configuration, the electrolyte solution can be impregnated into the stacked electrode assembly through a portion of the second side surface where the separators are not welded. Thus, the impregnation of the electrolyte solution into the stacked electrode assembly is facilitated, as compared to when the separators are welded on the entirety of the second side surface.

According to another aspect of the present disclosure, a power storage module includes: the stacked electrode assembly and a housing accommodating the stacked electrode assembly. An injection hole for injecting an electrolyte solution into the housing is formed in the housing. The injection hole is formed in an end portion of the housing in the second direction and closer to the first side surface than the second side surface. The separator is formed only on the second side surface between the first side surface and the second side surface.

With the above configuration, the electrolyte solution passes with ease toward the first side surface than toward the second side surface. Even though the electrolyte solution is prevented by the welded portion from flowing into the stacked electrode assembly, the impregnation of the electrolyte solution into stacked electrode assembly is facilitated, due to the welded portions being present only on the second side surface side, as compared to when the welded portions are formed on the first side surface side. Therefore, according to the power storage module, as the electrolyte solution is injected into the housing, the electrolyte solution can be efficiently impregnated inside the stacked electrode assembly, as compared to when the injection hole is formed closer to the second side surface than the first side surface.

Preferably, the separator is welded at a plurality of locations separate from each other in the second direction across the length of the stacked electrode assembly in the first direction. Lengths of the plurality of locations in the second direction are shorter as the plurality of locations are located farther away from the injection hole.

As the electrolyte solution is injected into the housing, most of the electrolyte solution, rather than impregnating into the stacked electrode assembly immediately, first, passes around the stacked electrode assembly, moving away from the injection hole. Subsequently, the electrolyte solution moves within stacked electrode assembly 100 from the side away from the injection hole toward the injection hole. Such an action allows the supply of the electrolyte solution across inside the stacked electrode assembly. In addition, as the amount of injection of the electrolyte solution increases over time, the electrolyte solution can be supplied into the stacked electrode assembly even from around the stacked electrode assembly. As noted above, since the separators farther away from the injection hole have shorter lengths in the second direction, the electrolyte solution can be efficiently impregnated into stacked electrode assembly 100C, starting from the portion of the second side surface of the stacked electrode assembly farthest away from the injection hole.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view of a power storage module.

FIG. 2 is a diagram showing a stacked electrode assembly included in the power storage module of FIG. 1.

FIG. 3 is a cross-sectional arrow view of the power storage module, taken along a III-III line of FIG. 1.

FIG. 4 is a diagram of the stacked electrode assembly of FIG. 3 as viewed in a predetermined orientation.

FIG. 5 is a diagram showing Variation 1 of the stacked electrode assembly.

FIG. 6 is a diagram showing Variation 2 of the stacked electrode assembly.

FIG. 7 is a diagram showing Variation 3 of the stacked electrode assembly.

FIG. 8 is a diagram showing Variation 4 of the stacked electrode assembly.

FIG. 9 is a diagram showing Variation 5 of the stacked electrode assembly.

FIG. 10 is a diagram showing Variation 6 of the stacked electrode assembly.

FIG. 11 is a diagram showing a lateral cross section of another power storage module.

### DESCRIPTION OF THE PREFERRED EMBODIMENTS

Hereinafter, an embodiment according to the present disclosure will be described, with reference to the accompanying drawings. Note that the embodiment below uses the same reference signs to refer to the same or common parts, and description thereof will not be repeated.

### Embodiment 1

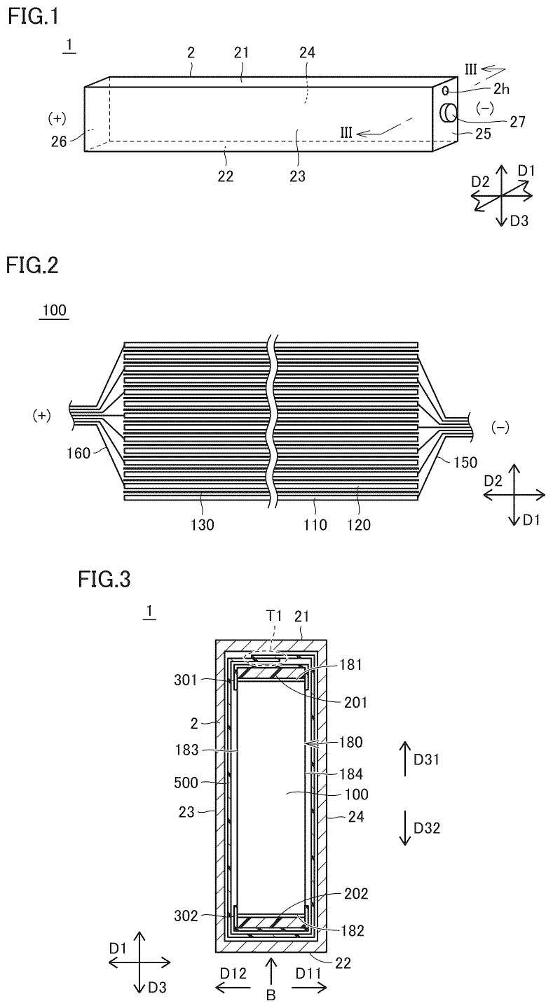

FIG. 1 is a perspective view of a power storage module according to the present embodiment. FIG. 2 is a diagram showing a stacked electrode assembly included in the power storage module of FIG. 1. As shown in FIGS. 1 and 2, a power storage module 1 has a blade shape. Power storage module 1 includes a stacked electrode assembly 100 and a housing 2 accommodating stacked electrode assembly 100. Note that, in the following, for convenience of illustration, power storage module 1 will be described, with reference to an example in which the power storage module 1 is oriented so that a D3 direction shown in FIGS. 1, 2, etc. is the vertical direction (more specifically, the orientation of D31 described below is vertically upward), except when an electrolyte solution is injected, which will be described below.

Power storage module 1 is, in this example, a lithium iron phosphate (LFP) battery. However, the present disclosure is not limited thereto. Power storage module 1 may be a nickel manganese cobalt (NMC) battery. Power storage module 1 is mounted on, for example, a battery electric vehicle traveling with a driving force obtained from electrical energy. Specifically, a battery pack, including multiple power storage modules 1 aligned in a predetermined direction, is mounted on a battery electric vehicle. The battery pack is mounted on the vehicle body of the battery electric vehicle. The battery pack constitutes a part of the vehicle body. The battery pack serves as the structure of the vehicle body.

As shown in FIG. 1, housing 2 has a generally cuboid shape. Housing 2, in this example, is made of metal. Housing 2 has first to sixth surfaces 21 to 26. A first surface 21, a second surface 22, a third surface 23, and a fourth surface 24 continue in the listed order. First surface 21, second surface 22, third surface 23, and fourth surface 24 constitute the outer circumferential surface of housing 2.

A fifth surface 25 and a sixth surface 26 are end surfaces of housing 2. First surface 21 is the top surface, second surface 22 is the bottom surface, and third surface 23 and fourth surface 24 are side surfaces. A negative-side external connection terminal 27 is disposed on fifth surface 25. A positive-side external connection terminal (not shown) is disposed on sixth surface 26.

As shown in FIG. 2, stacked electrode assembly 100 has multiple electrodes (a negative electrode 110, a positive electrode 120) and multiple separators 130. Stacked electrode assembly 100 includes multiple electrodes stacked in D1 direction (a laminate direction). Specifically, in stacked electrode assembly 100, negative electrode 110 and positive electrode 120 are alternately stacked in D1 direction via a separator 130. In other words, in stacked electrode assembly 100, negative electrode 110, separator 130, positive electrode 120, and separator 130 are repeatedly disposed in the listed order. Note that the D1 direction is the width direction of power storage module 1. Positive electrodes 120 have the same size. Negative electrodes 110 have the same size. Separators 130 have the same size.

The lengths of separators 130 in D3 direction are longer than the lengths of positive electrodes 120 in D3 direction. Similarly, the lengths of separators 130 in D3 direction are longer than the lengths of negative electrodes 110 in D3 direction.

Stacked electrode assembly 100 further includes tabs 150 connected to negative-side external connection terminal 27 and tabs 160 connected to the positive-side external connection terminal. Tab 150 is a collection of copper foils. Tab 160 is a collection of aluminum foils.

As shown in 1, power storage module 1 and housing 2 extend in D2 direction. As shown in 2, stacked electrode assembly 100 extends in D2 direction. D2 direction is perpendicular to D1 direction. D2 direction is the longitudinal directions of power storage module 1, housing 2, and stacked electrode assembly 100. D3 direction is perpendicular to D1 direction and D2 direction. D3 direction is the height direction of power storage module 1.

D1 direction is the lateral directions of first surface 21, second surface 22, fifth surface 25, and sixth surface 26. D2 direction is the longitudinal directions of first to fourth surfaces 21 to 24. D3 direction is the lateral directions of third and fourth surfaces 23 and 24 and the longitudinal directions of fifth and sixth surfaces 25 and 26.

An injection hole 2h is formed in fifth surface 25 for injecting an electrolyte solution into housing 2. Injection hole 2h is formed closer to first surface 21 of housing 2 than second surface 22. Injection hole 2h is formed closer to first surface 21 than external connection terminal 27. Note that in FIG. 1, since the electrolyte solution is already injected inside the housing 2, injection hole 2h is sealed. Injection hole 2h may be temporarily sealed by inserting a detachable stopper into injection hole 2h. Alternatively, injection hole 2h may be sealed with a resin or a metal so that no electrolyte solution can be injected into housing 2 again, unless the through-hole is opened.

FIG. 3 is a cross-sectional arrow view of power storage module 1, taken along a III-III line of FIG. 1. FIG. 3 is a diagram showing a lateral cross section of power storage module 1. As shown in 3, power storage module 1 further includes plate-like members 201 and 202, tape materials 301 and 302, and an insulating sheet 500, in addition to housing 2 and stacked electrode assembly 100.

Plate-like members 201 and 202, tape materials 301 and 302, and insulating sheet 500 are accommodated in housing 2, as with stacked electrode assembly 100. Plate-like members 201 and 202, tape materials 301 and 302, and insulating sheet 500 are disposed (in a gap) between stacked electrode assembly 100 and housing 2.

Plate-like members 201 and 202 extend in D2 direction. Plate-like members 201 and 202 are disposed within housing 2 so that the thickness direction of the plate-like member 201 is D3 direction. In this example, plate-like member 202 and plate-like member 201 have shapes that are symmetrical about stacked electrode assembly 100. However, the present disclosure is not limited thereto.

Multiple through-holes, extending in D3 direction, are formed in plate-like members 201 and 202. The through-holes that are alighted in D2 direction are formed in plate-like members 201 and 202. Note that the power storage module 1 may not necessarily include plate-like members 201 and 202.

Plate-like members 201 and 202 are insulators. In this example, plate-like members 201 and 202 are each formed of a resin. Plate-like members 201 and 202 are, in this example, each formed of an insulative material from the standpoint of prevention of a short circuit between positive electrode 120 and negative electrode 110 of stacked electrode assembly 100. Note that if an insulating distance is sufficiently secured between stacked electrode assembly 100 and plate-like members 201 and 202, plate-like members 201 and 202 may not necessarily be insulators.

For example, polypropylene is used as a material constituting plate-like members 201 and 202. However, the present disclosure is not limited thereto. For example, polyethylene, polyphenylene sulfide, poly ether ether ketone, or polyethylene terephthalate (PET) may be used.

Plate-like member 201 is disposed above the stacked electrode assembly 100. Specifically, plate-like member 201 is disposed directly above the stacked electrode assembly 100. Plate-like member 201 is placed on the first surface 21 side of housing 2. Plate-like member 201 is placed in the orientation of D31 of D3 direction, relative to stacked electrode assembly 100. Note that the orientation of D31 is vertically upward, as noted above.

Plate-like member 202 is disposed below the stacked electrode assembly 100. Specifically, plate-like member 202 is disposed directly below the stacked electrode assembly 100. Plate-like member 202 is placed on the second surface 22 side of housing 2. Plate-like member 202 is placed in the orientation of D32 of D3 direction, relative to stacked electrode assembly 100. Note that the orientation of D32 is vertically downward.

Plate-like member 201 is secured to stacked electrode assembly 100 by a tape material 301. Plate-like member 202 is secured to stacked electrode assembly 100 by a tape material 302. Tape materials 301 and 302 extend in D2 direction. Tape materials 301 and 302 cover portions of stacked electrode assembly 100.

Stacked electrode assembly 100 has a circumferential surface 180. Circumferential surface 180 extends in D2 direction. FIG. 3 shows a lateral cross-section of circumferential surface 180. The lateral cross-section of circumferential surface 180 has a rectangular shape. Circumferential surface 180 faces housing 2. Circumferential surface 180 faces the inner circumferential surface of housing 2. Circumferential surface 180 faces housing 2 with members such as insulating sheet 500 in-between.

Circumferential surface 180 of stacked electrode assembly 100 has first and second side surfaces 181 and 182 on the D3 direction side and first and second primary surfaces 183 and 184 on the D1 direction side. In other words, circumferential surface 180 has first and second side surfaces 181 and 182 whose normal directions are D3 direction and first and second primary surfaces 183 and 184 whose normal directions are D1 direction.

First side surface 181 continues to first and second primary surfaces 183 and 184. First side surface 181 is the top surface. Similarly, second side surface 182 continues to first and second primary surfaces 183 and 184. Second side surface 182 is the bottom surface.

First side surface 181 is in parallel to first surface 21 of housing 2. Second side surface 182 is in parallel to second surface 22. First side surface 181 is closer to first surface 21 of housing 2 than second side surface 182 is. First primary surface 183 is in parallel to third surface 23. Second primary surface 184 is in parallel to fourth surface 24. First primary surface 183 is closer to third surface 23 than second primary surface 184 is. The widths of first and second side surfaces 181 and 182 in D1 direction are narrower than the widths of first and second primary surfaces 183 and 184 in D3 direction.

Insulating sheet 500 is disposed between circumferential surface 180 of stacked electrode assembly 100 and housing 2 and covers circumferential surface 180. Insulating sheet 500 insulates stacked electrode assembly 100 and housing 2 from each other. Insulating sheet 500 covers stacked electrode assembly 100 to prevent stacked electrode assembly 100 from touching housing 2. Insulating sheet 500 is provided between stacked electrode assembly 100 and housing 2 (specifically, the inner surface of the housing) to prevent a short circuit of stacked electrode assembly 100.

Specifically, insulating sheet 500 covers plate-like members 201 and 202. Insulating sheet 500 covers plate-like member 201 via tape material 301. Similarly, insulating sheet 500 covers plate-like member 202 via tape material 302.

The opposing end portions of insulating sheet 500 are welded together. Insulating sheet 500 is wrapped around tape materials 301 and 302, plate-like members 201 and 202, and stacked electrode assembly 100, while plate-like members 201 and 202 are secured to stacked electrode assembly 100 by tape materials 301 and 302. Subsequently, the opposing end portions of insulating sheet 500 are welded together, and insulating sheet 500 of FIG. 3 results. The opposing end portions of insulating sheet 500 overlap in a welded region T. Welded region T extends in D2 direction. Note that multiple insulating sheets may be coupled together to form insulating sheet 500.

Note that, for example, polypropylene is used as a material constituting insulating sheet 500. However, the present disclosure is not limited thereto. For example, polyethylene, polyphenylene sulfide, poly ether ether ketone, nylon, or polyethylene terephthalate (PET) may be used.

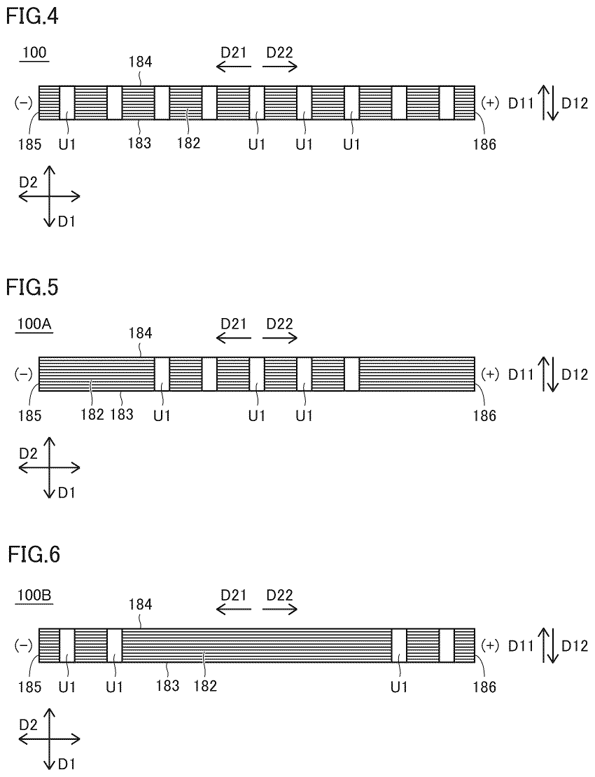

FIG. 4 is a diagram showing stacked electrode assembly 100 of FIG. 3 as viewed in the orientation indicated by an arrow B. As shown in FIG. 4, stacked electrode assembly 100 further includes a first end surface 185 and a second end surface 186, in addition to first side surface 181, second side surface 182, first primary surface 183, and second primary surface 184.

First end surface 185 is the surface on the side of fifth-surface 25 having negative-side external connection terminal 27 (FIG. 1) disposed thereon. Second end surface 186 is the surface on the side of sixth surface 26 (FIG. 1) having the positive-side external connection terminal disposed thereon.

Separators 130 are welded on second side surface 182 across the length of stacked electrode assembly 100 in D1 direction. With such a configuration, the movement of separators 130 in D3 direction within stacked electrode assembly 100 is restricted. Therefore, according to stacked electrode assembly 100, the misalignment of separators 130 can be prevented. Furthermore, according to stacked electrode assembly 100, the amounts of protrusions of separators 130 from the outer edges of negative electrode 110 and positive electrode 120 can be reduced. Thus, according to stacked electrode assembly 100, a reduced space not contributing to charging and discharging can be achieved.

Specifically, separators 130 are welded together at multiple locations, separate from each other in D2 direction, across the length of stacked electrode assembly 100 in D1 direction. In the present embodiment, separators 130 are directly welded together. Stacked electrode assembly 100 includes multiple welded portions U1 that are formed by separators 130 being welded together.

Welded portions U1 has the same length in D1 direction. This length in D1 direction is about the same as the length of stacked electrode assembly 100 in D1 direction. Welded portions U1 has the same length in D2 direction. In this example, welded portions U1 are uniformly formed in D2 direction. Separation distances between adjacent welded portions U1 are the same. Each welded portion U1 is, typically, formed by separators 130 being touched by a hot iron.

Each welded portion U1 covers a portion of positive electrode 120 and a portion of negative electrode 110 in D1 direction when stacked electrode assembly 100 is viewed from the second side surface 182 side. Each welded portion U1 may be in contact with the outer edge portion of positive electrode 120 and the outer edge portion of negative electrode 110.

Welded portions U1 allow separators 130 to be secured to each other. Locations of separators 130 relative to each other are fixed on the second side surface 182 side. Therefore, the movement of separators 130 in D3 direction within stacked electrode assembly 100 is restricted. As such, according to power storage module 1, separators 130 can be prevented from misalignment. Furthermore, the welded portions can be reduced, as compared to when separators 130 are welded together across the entirety of second side surface 182.

As noted above, since separator 130 are directly welded together, separators 130 can be locked in position, without having to employ other members. Furthermore, in power storage module 1, since welded portions U1 are uniformly formed in D2 direction as noted above, the effect of prevention of misalignment of separators 130 is high, as compared to when separators 130 are not uniformly formed.

Each positive electrode 120 and each negative electrode 110 are each sandwiched between separators 130. Therefore, movement of positive electrode 120 and negative electrode 110 in D3 direction relative to separator 130 can be restricted. Specifically, the misalignment of positive electrodes 120 and negative electrodes 110 in the orientation of D31 relative to separators 130 can be reduced too.

Furthermore, power storage module 1 has the following advantageous effects when the electrolyte solution is injected into housing 2 through injection hole 2h (FIG. 1). When the electrolyte solution is injected into housing 2 through injection hole 2h, for example, during the manufacturing of power storage module 1, the orientation of power storage module 1 is kept so that D2 direction is substantially the vertical direction and fifth surface 25 is located above the sixth surface 26. Due to the self-weight of the electrolyte solution, the electrolyte solution flows from the fifth surface 25 side to the sixth surface 26 side. Note that the electrolyte solution, since it has a certain degree of viscosity, falls within housing 2 at a slow speed. This allow the electrolyte solution to be impregnated into stacked electrode assembly 100.

In this regard, separators 130 are not welded together between welded portions U1 on second side surface 182 of stacked electrode assembly 100 as noted above. Therefore, as the electrolyte solution falls down or the fallen electrolyte solution rises up within housing 2, the electrolyte solution can be impregnated into stacked electrode assembly 100 through a portion of second side surface 182 where separators 130 are not welded together (hereinafter, also referred to as a “non-welded portion”). Note that since first side surface 181 includes no welded portion U1, as the electrolyte solution falls down within housing 2, the electrolyte solution can be impregnated into stacked electrode assembly 100 from the entirety of first side surface 181.

As such, separators 130 are welded together at multiple locations on second side surface 182 across the length of stacked electrode assembly 100 in D1 direction, thereby facilitating the impregnation of the electrolyte solution into stacked electrode assembly 100, as compared to when separators 130 are welded on the entirety of second side surface 182.

Meanwhile, injection hole 2h is formed closer to the first surface 21 of housing 2 than second surface 22 as noted above. Injection hole 2h is located closer to first side surface 181 of stacked electrode assembly 100 than second side surface 182, in D3 direction. In other words, first side surface 181 having no welded portion U1 formed thereon is located closer to injection hole 2h than second surface 22 having welded portions U1 formed thereon is.

Since injection hole 2h is closer to first side surface 181 than second side surface 182, as the electrolyte solution is gravity flown into stacked electrode assembly 100 in D2 direction through injection hole 2h, the electrolyte solution passes with ease toward the first side surface 181 than toward the second side surface 182. Even though the electrolyte solution is prevented by welded portions U1 from flowing into stacked electrode assembly 100, the impregnation of the electrolyte solution into stacked electrode assembly 100 is facilitated, due to welded portions U1 being present only on the second side surface 182 side, as compared to when welded portions U1 are formed on the first side surface 181 side.

Therefore, with such a configuration, as the electrolyte solution is injected into housing 2, the electrolyte solution can be efficiently impregnated inside the stacked electrode assembly 100, as compared to when injection hole 2h is formed closer to second side surface 182 than first side surface 181.

Note that multiple welded portions U1 may be formed on first side surface 181 (FIG. 3), similarly to second side surface 182. In this case, the misalignment of separators 130 can further be prevented, as compared to when separators 130 are welded on second side surface 182. Furthermore, with such a configuration, the misalignment of positive electrodes 120 and negative electrodes 110 in the orientation of D32 relative to separators 130 can be reduced too. Thus, with this configuration, the misalignment of positive electrodes 120 and negative electrodes 110 in D3 direction relative to separators 130 can be reduced.

The present disclosure is not limited to the above, and welded portion U1 may be formed only on first side surface 181 between first side surface 181 and second side surface 182. Separator 130 may be welded on at least one of first side surface 181 and second side surface 182 across the length of stacked electrode assembly 100 in D1 direction.

In this example, injection hole 2h is formed closer to first surface 21 than external connection terminal 27. However, the present disclosure is not limited thereto. Injection hole 2h may be formed closer to second surface 22 than external connection terminal 27. Injection hole 2h may be formed closer to third surface 23 than external connection terminal 27. Injection hole 2h may be formed closer to fourth surface 24 than external connection terminal 27.

Further in this example, injection hole 2h is formed in fifth surface 25. However, the present disclosure is not limited thereto. For example, injection hole 2h may be formed in sixth surface 26. Injection hole 2h may be formed in first surface 21 or second surface 22. When injection hole 2h is formed in first surface 21 or second surface 22, preferably, injection hole 2h is formed closer to the end side (the fifth surface 25 side or the sixth surface 26 side) of housing 2 in the longitudinal direction than the middle portion from the standpoint of liquid injection property. Injection hole 2h may be formed in third surface 23 or fourth surface 24. The location of formation of injection hole 2h is not particularly limited.

### SUMMARY

As described above, power storage module 1 includes stacked electrode assembly 100 having the electrolyte solution impregnated therein, and housing 2 accommodating stacked electrode assembly 100. As shown in FIG. 2, stacked electrode assembly 100 includes positive electrode 120, separator 130, and negative electrode 110 which are alternately stacked in D1 direction and extend in D2 direction perpendicular to D1 direction.

As shown in FIG. 3, stacked electrode assembly 100 has circumferential surface 180 extending in D2 direction and facing the housing 2 (specifically, the inner circumferential surface of the housing). The length of separator 130 in D3 direction perpendicular to D1 direction and D2 direction is longer than the lengths of positive electrodes 120 and negative electrodes 110 in D3 direction. As shown in FIG. 3, circumferential surface 180 has first and second primary surfaces 183 and 184 in D1 direction, and first and second side surfaces 181 and 182 in D3 direction, the first and second side surfaces 181 and 182 continuing to first and second primary surfaces 183 and 184, respectively.

As shown in FIG. 3, the widths of first and second side surfaces 181 and 182 in D1 direction are narrower than the widths of first and second primary surfaces 183 and 184 in D3 direction. In the example of FIG. 4, separators 130 are welded on second side surface 182 across the length of stacked electrode assembly 100 in D1 direction.

Specifically, as shown in FIG. 4, separators 130 are welded together at multiple locations separate from each other in D2 direction across the length of stacked electrode assembly 100 in D1 direction.

More specifically, as shown in FIG. 1, housing 2 has an injection hole 2h for injecting the electrolyte solution into power storage module 1. As shown in FIG. 1, injection hole 2h is formed in the end portion of housing 2 in D2 direction and closer to first side surface 181 than second side surface 182. As shown in FIG. 4, separators 130 are welded only on second side surface 182 between first side surface 181 and second side surface 182. Note that the present disclosure is not limited thereto, and separators 130 may be welded on at least one of first side surface 181 and second side surface 182 across the length of stacked electrode assembly 100 in D1 direction.

### Variations

In the following, variations of stacked electrode assembly 100 are described. Specifically, variations with respect to the locations of formation of the welded portions of separators 130 will be described.

### (1) Variation 1

FIG. 5 is a diagram showing Variation 1 of stacked electrode assembly 100. As shown in FIG. 5, in a stacked electrode assembly 100A, separators 130 are welded on second side surface 182 across the length of stacked electrode assembly 100A in D1 direction, as with stacked electrode assembly 100. Specifically, separators 130 are welded across the length of stacked electrode assembly 100A in D1 direction at locations separate from each other in D2 direction. Separators 130 are directly welded together. Stacked electrode assembly 100A includes multiple welded portions U1 that are formed by separators 130 being welded together.

In stacked electrode assembly 100A, welded portions U1 are present unevenly on the middle portion of second side surface 182 in D2 direction. In stacked electrode assembly 100A, no welded portion U1 is present at the end portions of second side surface 182 in D2 direction.

According to stacked electrode assembly 100A having such a configuration, the same advantageous effects as those of stacked electrode assembly 100 are achieved. Furthermore, according to stacked electrode assembly 100A, impregnation of the electrolyte solution into the stacked electrode assembly is facilitated, as compared to stacked electrode assembly 100. In particular, according to stacked electrode assembly 100A, impregnation of the electrolyte solution from opposing end portions of second side surface 182 in D2 direction is facilitated, as compared to stacked electrode assembly 100.

### (2) Variation 2

FIG. 6 is a diagram showing Variation 2 of stacked electrode assembly 100. As shown in FIG. 6, in a stacked electrode assembly 100B, separators 130 are welded on second side surface 182 across the length of stacked electrode assembly 100B in D1 direction, as with stacked electrode assembly 100. Specifically, separators 130 are welded together across the length of stacked electrode assembly 100B in D1 direction at locations separate from each other in D2 direction. Separators 130 are directly welded together. Stacked electrode assembly 100B includes multiple welded portions U1 that are formed by separators 130 being welded together.

In stacked electrode assembly 100B, welded portions U1 are present unevenly at the end portions of second side surface 182 in D2 direction. In stacked electrode assembly 100B, no welded portion U1 is present on the middle portion of second side surface 182 in D2 direction.

According to stacked electrode assembly 100B having such a configuration, the same advantageous effects as those of stacked electrode assembly 100 are achieved. Furthermore, according to stacked electrode assembly 100B, impregnation of the electrolyte solution into the stacked electrode assembly is facilitated, as compared to stacked electrode assembly 100. In particular, according to stacked electrode assembly 100B, impregnation of the electrolyte solution from the middle portion of second side surface 182 in D2 direction is facilitated, as compared to stacked electrode assembly 100.

### (3) Variation 3

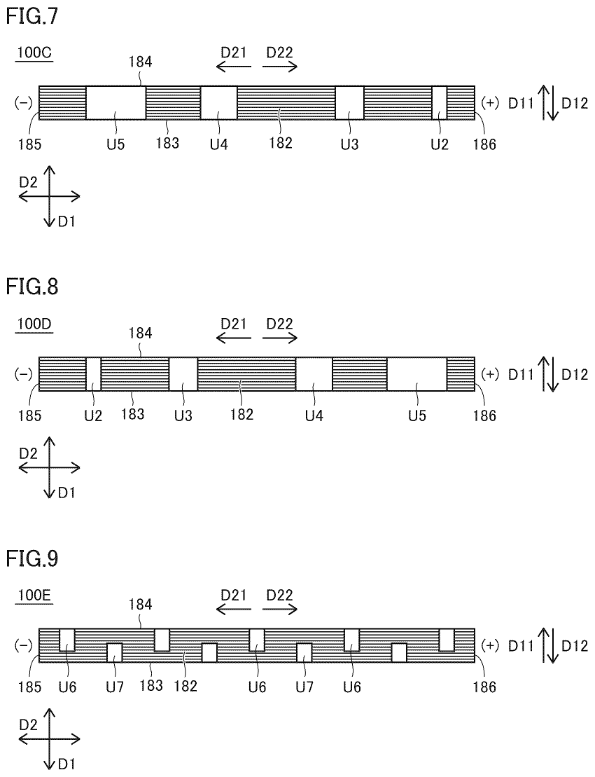

FIG. 7 is a diagram showing Variation 3 of stacked electrode assembly 100. As shown in FIG. 7, in a stacked electrode assembly 100C, separators 130 are welded on second side surface 182 across the length of stacked electrode assembly 100C in D1 direction, as with stacked electrode assembly 100. Specifically, separators 130 are welded across the length of stacked electrode assembly 100C in D1 direction at locations separate from each other in D2 direction. Separators 130 are directly welded together.

Stacked electrode assembly 100C includes multiple welded portions U2, U3, U4, and U5 which are formed by separators 130 being welded together. Welded portion U2, welded portion U3, welded portion U4, and welded portion U5 are present in the listed order from the second end surface 186 side toward first end surface 185.

The lengths of welded portions U2, U3, U4, and U5 in D1 direction are the same as the length of welded portion U1 in D1 direction. Welded portions U2, U3, U4, and U5 have lengths (widths) in D2 direction in order starting from the shortest to the longest. Welded portions U2, U3, U4, and U5 farther away from fifth surface 25 (the first end surface 185 side surface) of housing 2 have shorter lengths (widths) in D2 direction. In other words, welded portions U2, U3, U4, and U5 farther away from injection hole 2h have shorter lengths (widths) in D2 direction.

Meanwhile, as the electrolyte solution is injected into housing 2, most of the electrolyte solution, rather than impregnating into stacked electrode assembly 100C immediately, first, passes around stacked electrode assembly 100C, moving (falling down) from the first end surface 185 side to the side (the second end surface 186 side) away from injection hole 2h. Subsequently, due to the capillary action, the electrolyte solution moves (rises up) within stacked electrode assembly 100C from the side (the second end surface 186 side) away from injection hole 2h toward the first end surface 185 side (the injection hole 2h side). Such an action allows the supply of the electrolyte solution across inside the stacked electrode assembly 100C.

In addition, as the amount of injection of the electrolyte solution increases over time, the electrolyte solution can be supplied into stacked electrode assembly 100C even from around stacked electrode assembly 100C. At this time, since the welded portions farther away from injection hole 2h has shorter lengths (widths) in D2 direction, the electrolyte solution can be efficiently impregnated into stacked electrode assembly 100C, starting from the portion (specifically, non-welded portion) of second side surface 182 of stacked electrode assembly 100C farthest away from injection hole 2h.

### (4) Variation 4

FIG. 8 is a diagram showing Variation 4 of stacked electrode assembly 100. As shown in FIG. 8, in a stacked electrode assembly 100D, separators 130 are welded on second side surface 182 across the length of stacked electrode assembly 100D in D1 direction, as with stacked electrode assembly 100. Specifically, separators 130 are welded together at multiple locations separate from each other in D2 direction across the length of stacked electrode assembly 100D in D1 direction. Separators 130 are directly welded together.

Stacked electrode assembly 100D includes multiple welded portions U2, U3, U4, and U5 which are formed by separators 130 being welded together, as with stacked electrode assembly 100C. Unlike stacked electrode assembly 100C, in stacked electrode assembly 100D, welded portion U5, welded portion U4, welded portion U3, and welded portion U2 are present in the listed order from the second end surface 186 side toward first end surface 185.

In stacked electrode assembly 100D, welded portions U2, U3, U4, and U5 closer to fifth surface 25 of housing 2 (the first end surface 185 side surface) have shorter lengths (widths) in D2 direction. In other words, welded portions U2, U3, U4, and U5 closer to injection hole 2h have shorter lengths (widths) in D2 direction.

According to stacked electrode assembly 100D having such a configuration, the same advantageous effects as those of stacked electrode assembly 100 are achieved. In addition, as the electrolyte solution is injected into housing 2, the electrolyte solution moving (falling down) from the first end surface 185 side towards the side away from injection hole 2h can be efficiently impregnated into stacked electrode assembly 100D.

### (5) Variation 5

FIG. 9 is a diagram showing Variation 5 of stacked electrode assembly 100. As shown in FIG. 9, in a stacked electrode assembly 100E, separator 130 are welded on second side surface 182 across the length of stacked electrode assembly 100E in D1 direction, as with stacked electrode assembly 100. Specifically, separators 130 are welded together at multiple locations separate from each other in D2 direction across the length of stacked electrode assembly 100E shorter than the length (the thickness) of stacked electrode assembly 100E in D1 direction. Separators 130 are directly welded together.

Stacked electrode assembly 100E includes multiple welded portions U6 and multiple welded portions U7 that are formed by separators 130 being welded together. In stacked electrode assembly 100E, welded portion U6 and welded portion U7 are alternately formed in D2 direction. Welded portion U6 and welded portion U7 partially overlap in D1 direction when stacked electrode assembly 100E is viewed in the orientation of D21, for example. This overlap locks all the separators 130 in position.

Specifically, welded portions U6 are formed equidistantly in D2 direction. Welded portions U6 are formed extending from second primary surface 184 toward first primary surface 183 in D1 direction. Welded portions U6 do not reach first primary surface 183. Welded portions U6 extend from second primary surface 184 to a location between first primary surface 183 and an intermediate position of second side surface 182 in D1 direction.

Similarly, welded portions U7 are formed equidistantly in D2 direction. Welded portions U7 are formed extending from first primary surface 183 toward second primary surface 184 in D1 direction. Welded portions U7 do not reach second primary surface 184. Welded portions U7 extend from first primary surface 183 to a location between second primary surface 184 and an intermediate position of second side surface 182 in D1 direction.

According to stacked electrode assembly 100E having such a configuration, the same advantageous effects as those of stacked electrode assembly 100 are achieved.

### (6) Variation 6

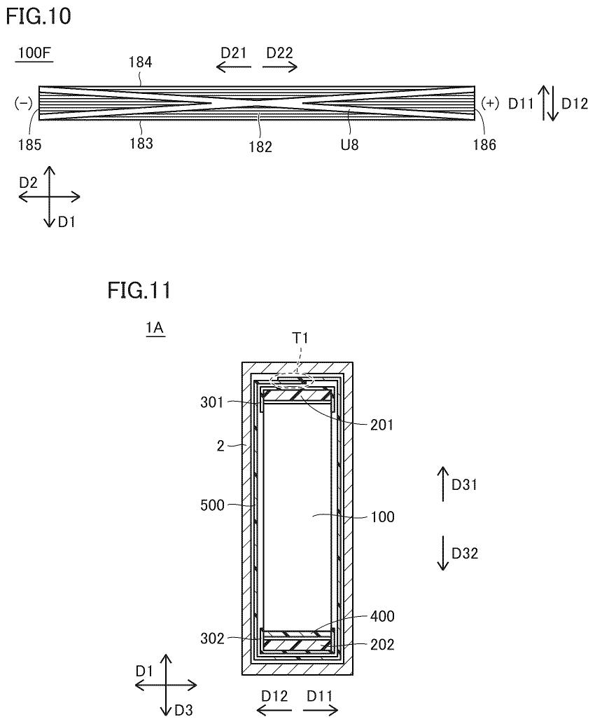

FIG. 10 is a diagram showing Variation 6 of stacked electrode assembly 100. As shown in FIG. 10, in a stacked electrode assembly 100F, separators 130 are welded on second side surface 182 across the length of stacked electrode assembly 100F in D1 direction, as with stacked electrode assembly 100. Separators 130 are directly welded together.

One welded portion U8 is formed on stacked electrode assembly 100F. Welded portion U8 has a X-shape when second side surface 182 is viewed in the orientation of D31. Welded portion U8 is formed by separators 130 welded together in two regions separate from each other in D1 direction at opposing end portions of second side surface 182 in D2 direction. On the middle portion of second side surface 182 in D2 direction, separators 130 are welded together only in one region in D1 direction.

According to stacked electrode assembly 100C having such a configuration, the same advantageous effects as those of stacked electrode assembly 100 are achieved. Furthermore, welding of all the separators 130 is facilitated by one welding process.

### Embodiment 2

The present embodiment is now described with respect to differences from power storage module 1 according to Embodiment 1.

FIG. 11 is a diagram showing a lateral cross section of a power storage module 1A according to the present embodiment. As shown in FIG. 11, power storage module 1A has a housing 2, a stacked electrode assembly 100, plate-like members 201 and 202, tape materials 301 and 302, an insulating sheet 500, and a plate-like member 400.

Power storage module 1A is the same as the power storage module 1 according to Embodiment 1, except that the power storage module 1A includes plate-like member 400. Plate-like member 400 is located between stacked electrode assembly 100 and plate-like member 202. Plate-like member 400 extends, not only in D1 direction, but also in D2 direction. Plate-like member 400 is, typically, a resin material.

Similarly to power storage module 1, in power storage module 1A, separators 130 are welded on second side surface 182 across the length of stacked electrode assembly 100 in D1 direction. Specifically, in power storage module 1A, separators 130 of stacked electrode assembly 100 are welded to plate-like member 400. As such, in power storage module 1A, separators 130 are welded together via plate-like member 400.

Preferably, plate-like member 400 is configured of multiple component members disposed spaced apart from each other in D2 direction. For example, each component member may be placed at a location corresponding to welded portion U1 of FIG. 4 and heat welded to a separator 130. The placement of each component member is not limited thereto, and the component member may be placed at a location corresponding to the welded portions of FIGS. 5 to 11.

According to power storage module 1A having such a configuration, the same advantageous effects as those provided by power storage module 1 according to Embodiment 1 can be achieved. Furthermore, in power storage module 1A, since plate-like member 400 is used, it is easy to lock separators 130 in position, as compared to directly welding separators 130 together as in Embodiment 1.

Similarly to power storage module 1 according to Embodiment 1, power storage module 1A includes stacked electrode assembly 100. Accordingly, as described in Embodiment 1, the misalignment of separators 130 can be prevented and the space not contributing to charging and discharging can be reduced in the present embodiment too.

Note that the plate-like member 400 may be located between stacked electrode assembly 100 and plate-like member 201. Plate-like member 400 may be disposed between stacked electrode assembly 100 and plate-like member 202 and between stacked electrode assembly 100 and plate-like member 201.

While the embodiments according to the present disclosure has been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A stacked electrode assembly, comprising:
a plurality of electrodes; and
a plurality of separators, wherein
each of the electrodes and each of the separators are alternately stacked in a first direction,
the stacked electrode assembly extends in a second direction perpendicular to the first direction and further includes a circumferential surface extending in the second direction, wherein
a length of the separator in a third direction perpendicular to the first direction and the second direction is longer than a length of the electrode in the third direction,
the circumferential surface has first and second primary surfaces in the first direction and first and second side surfaces in the third direction, the first and second side surfaces continuing to the first and second primary surfaces, respectively, and
the separator is welded on at least one of the first side surface and the second side surface across a length of the stacked electrode assembly in the first direction.

2. The stacked electrode assembly according to claim 1, wherein
the separator is welded together at a plurality of locations separate from each other in the second direction across the length of the stacked electrode assembly in the first direction.

3. A power storage module, comprising:
the stacked electrode assembly according to claim 1;
a housing accommodating the stacked electrode assembly, wherein
an injection hole for injecting an electrolyte solution into the housing is formed in the housing,
the injection hole is formed in an end portion of the housing in the second direction and closer to the first side surface than the second side surface, and
the separator is formed only on the second side surface between the first side surface and the second side surface.

4. The power storage module according to claim 3, wherein
the separator is welded at a plurality of locations separate from each other in the second direction across the length of the stacked electrode assembly in the first direction, and
lengths of the plurality of locations in the second direction are shorter as the plurality of locations are located farther away from the injection hole.
